(19) United States
(12) Patent Application Publication
(10) Pub. No.: US 2004/0117732 A1
(43) Pub. Date: Jun. 17, 2004

(54) Method of and apparatus for creating a computer document

(76) Inventors: Leon Curtis McNeill, Bexley (GB); Matthew James Gough, Maidstone (GB); Matthew David Avent, London (GB); Reza-Ali Farhad-Motamed, London (GB)

Correspondence Address: Clark & Brody, Suite 600, 1750 K Street, NW, Washington, DC, 20006, US

(21) Appl. No.: 10/319,530

(22) Filed: Dec. 16, 2002

(51) Int. Cl. G06F 15/00

(52) U.S. Cl. 715/513; 715/530; 715/517

(57) ABSTRACT

A method of and apparatus for creating a computer document comprising downloading a plurality of hyper text markup language (HTML) documents and interpreting the HTML code of each HTML document downloaded, to create a hierarchy of layout objects representing the flow of text and graphics contained within each HTML document A series of layout objects of all the HTML documents downloaded arc compiled, in user selected order, thereby to create a single user-editable computer document comprising the said series and those HTML documents in that selected order, so that the document comprises a plurality of web pages as they appear in a web browser, but is editable as with a word processor as a single document.

### TECHNICAL FIELD

The present invention relates to a method of creating a computer document, as well as to apparatus for enabling the creation of a computer document.

### BACKGROUND OF THE INVENTION

The potential for using the worldwide web as a far-reaching research tool has only begun to be tapped by most computer users, with three primary barriers restricting this kind of use. First, the ephemeral, changing nature of many web pages often leads, over time, to broken links and indecipherable server messages. Secondly, bookmarking dozens of web pages can quickly get out of control and become disorganised. Thirdly, the uneditable state of web pages often results in the inclusion of redundant or irrelevant information.

“Related art” includes many software applications with limited, related functionality to this invention.

Dozens of software utilities exist which allow the user to download multiple web pages en masse, reproducing the set of directories, HTML documents, and image files found on a source web page server computer. These utilities are often referred to as “offline browsers”, as after using such a utility to download most or all of a particular web site, a web browser can then be used to view the resulting files on the user's own hard disk without being “online”, that is, connected to the Internet. These utilities are typically only useful for gatherinq an arbitrarily sized group of web pages from a single web server. These utilities generally have no capability to edit the downloaded files beyond the capability to adjust the web site addresses of embedded links in order to redirect them to the locally downloaded copies when necessary. Therefore, this approach provides a solution to the issue of the ephemeral nature of web sites, but in itself does little to help with the editing out of irrelevant information, and does nothing to maintain a coherent linear organisation of the gathered data. Utilities in this category include WebCopier, Website Extractor, WebWhacker, PageSucker, Web Devil, and Web Dumper.

Similarly, Microsoft's Internet Explorer web browser has a feature which allows the user to archive a web page and any other web pages linked from it, up to five levels deep, to a hard disk. The resulting “Web Archive” tile represents copies of the web pages, though when using this Web Archive with Internet Explorer later, web pages still appear one web page at a time, with no linear organisation or editing capability.

Web page editors such as Macromedia Dreamweaver, Microsoft FrontPage, and Netscape Communications' Netscape (Composer feature) will allow you to edit the HTML of web pages in a relatively straightforward “WYSTWYG” (what-you-sec-is-what-you-get) manner. However, these editors must be used along with an above-mentioned “offline browser” utility in order to make local copies of any web pages of interest before any editing can occur. Again, no linear organisation of multiple web pages exists with this approach.

Microsoft's Word word processor allows a user to open” a web page, which will download the web page and convert it into Word's custom document format. While images from the web page are imported, their layout is often very poor and difficult to adjust. Web pages must be imported one at a time into separate documents.

Finally, an approach taken by many who need to gather information on the Internet is to use the modern computer operating system's capability to “copy” relevant text from a web browser and “paste” it into a word processor document, maintaining a sensible linear organisation and disregarding irrelevant information. Such an approach loses most of the layout and formatting inherent in web page design, and any images on the web page that the user wants to retain must be manually moved and placed into the word processor document.

The present invention seeks to obviate one or more of the foregoing disadvantages, and seeks to provide a system in doing so that covers desired information from the Internet and/or other sources, such as the server of a local network or even one of the memory devices of a computer for the time being in use.

### SUMMARY OF THE INVENTION

Accordingly, the present invention is directed to a method of creating a computer document comprising downloading a plurality of hyper text markup language (HTML) documents, interpreting the HTML code of each HTML document downloaded, to create a hierarchy of layout objects representing the flow of text and graphics contained within each HTML document, and compiling a series of layout objects of all the HTML documents downloaded, in user selected order, thereby to create a single user-editable computer document comprising the said series and those HTML documents in that selected order, so that the document comprises a plurality of web pages as they appear in a web browser, but is editable as with a word processor as a single document.

Preferably, at least one of the HTML documents is downloaded from the Internet.

In order to assist in keeping track of whether any amendments have been made to the editable computer document, the method may further comprise an editing indicator to provide an indication of whether any alterations have been made to the editable computer document since it was originally created.

It is desirable for the date on which each HTML document was downloaded, as well as the address of each HTML document, to be retained in the created editable computer document. This provides an indication, in respect of each HTML document composing the editable computer document to be compared with the source of that HTML document to check whether the source HTML document has been updated since it was last downloaded into the editable computer document.

The ability of the method to maintain up-to-date information in the editable computer document is improved if the method further incorporates the step of comparing the date of each HTML document composing the editable computer document with the current date of the source of that HTML document, and transferring the HTML document from its source in the event that the latter has been updated since it was last downloaded to the said editable computer document.

This feature may be even more useful if the method includes the step of incorporating automatically any alterations that have been made to the HTML document as it was when last downloaded into the said editable computer document, to the updated HTML document now being incorporated into the said editable computer document in place of that document as previously downloaded and edited.

Preferably, the method includes means to edit the said editable computer document. Such editing may included deleting a portion of the said editable computer document, automatically finding and deleting all the occurrences of a selected text or graphic detail throughout the said editable computer document, and automatically finding all the occurrences matching a selected text or graphic detail and replacing it with a selected different text or graphic detail throughout the said editable computer document.

The method may include the step of storing any associated textual information, graphical information, and source address of related HTML documents, provided at the source of each HTML document downloaded into the said editable computer document, in the said editable computer document.

The method may comprise the step of generating a fully formatted printout of the said editable computer document.

The usefulness of the method is improved if it includes the step of automatically generating a table of contents of the said editable computer document, and even more so if chat table of contents indicates on each page of the editable computer document each HTML document composing the said editable computer document.

The method is further improved if it provides the step of maintaining a list of important index words constituting the said editable computer document. This is especially useful if that step includes the automatic generation of a full lexical index indicating the locations in the said editable computer document in which each index word appears.

The present invention extends to apparatus for enabling the creation of a computer document, comprising a downloader which serves to download a plurality of HTML documents, an interpreter connected to receive the HTML codes of the HTML documents downloaded by the downloader and to interpret them, thereby to create a hierarchy of layout objects representing the flow of text and graphics contained within each HTML document, and a compiler which serves to compile a series of layout objects of all the HTML documents downloaded, in user selected order, thereby to create a single user-editable computer document comprising the said series and those HTML documents in that selected order, so that the document comprises a plurality of web pages as they appear in a web browser, but is editable as with a word processor as a single document.

### BRIEF DESCRIPTION OF THE DRAWINGS

An example of a method and of apparatus embodying the present invention will now be described in greater detail with reference to the accompanying drawings, in which:

FIG. 1 is a front elevational view of apparatus embodying the present invention;

FIG. 2 is a view of a screen of the apparatus of FIG. 1 showing images provided by a method embodying the present invention operating on the apparatus shown in FIG. 1; and

FIG. 3 is a block schematic diagram of the program structure of the method.

### DETAILED DESCRIPTION OF THE PREFERRED EMBODIMENT

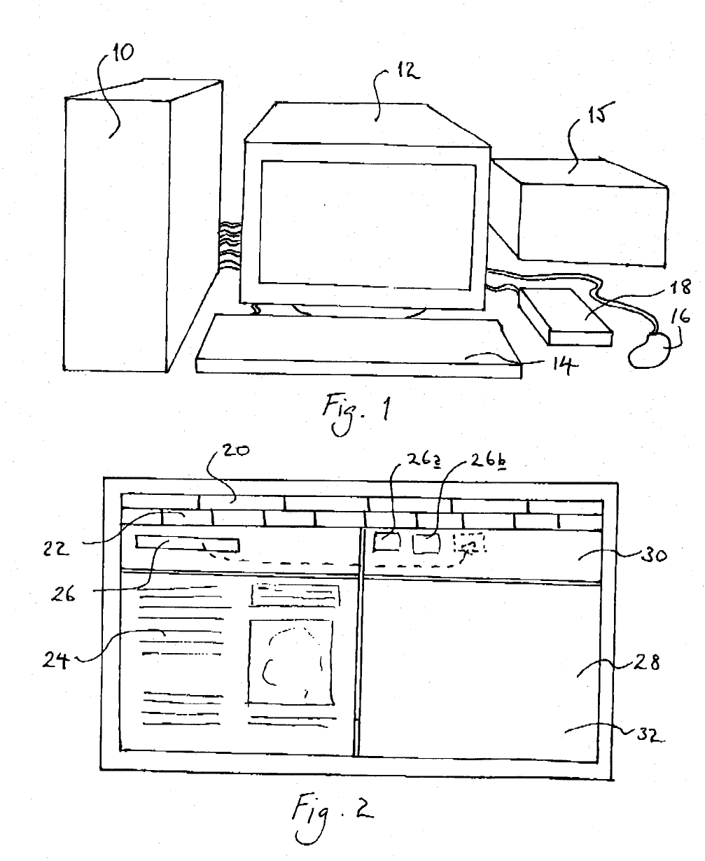

The apparatus shown in FIG. 1 comprises a Macintosh personal computer using the OS X operating system with a high speed Internet connection. Thus, it is provided with a main processor unit 10 connected to a monitor 12, a keyboard 14, a printer 15, a mouse 16, and a network interface modem 18.

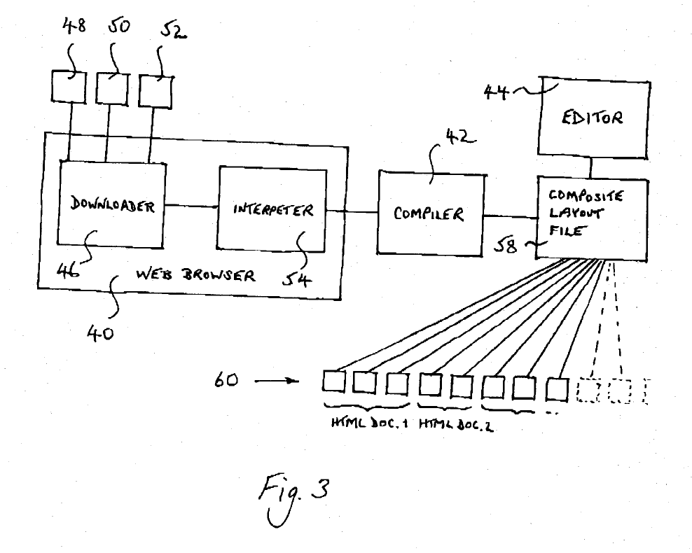

The main processor unit 10 is programmed to operate a method of creating a computer document in accordance with the present invention. As a result, when the program is being run, the monitor 12 displays an image on the monitor 12 as shown in FIG. 2. This image comprises a bar of menu headings 20, a toolbar 22, a web browser window 24 on the left-hand side of the monitor which includes a region 26 for entering a selected website address or in which is shown a website address of a web page that is for the time being present on the web browser, and a document window 28 on the right-hand side of the monitor screen. This latter comprises an upper portion 30 for displaying a list of website addresses, and a lower portion 32 for displaying the contents of a portion of a document which is being created or edited.

The structure of the computer program which is loaded on to the processor unit 10 is shown diagrammatically in FIG. 3. It comprises a web browser 40 coupled to a compiler 42 and, indirectly, to a text/graphics editor 44.

The web browser itself comprises a downloader 46 capable of selectively linking to The worldwide web 48, a local network 50, of which the processor unit 10 forms a part, or other parts 52 of the processor unit 10 itself, such as a compact disk drive unit thereof or a hard disk thereof or a floppy disk drive thereof. The downloader 46 is coupled to an interpreter 54 which in turn is connected to the compiler 42. This in turn is linked to create a composite layout file 58 providing links to HTML files 60 which make up a series of HTML documents downloaded on to the unit 10 by the downloader 46. Groups of these files constitute a successive series of HTML documents downloaded by the user by means of the downloader 46 in the order in which the user selects them. Thus, for example, in FIG. 3 the first three HTML files 60 constitute the first HTML document, the next two constitute the second HTML document downloaded by the user, and so on. When the apparatus shown in FIG. 1 is in use operating the program shown in FIG. 3, a screen is obtained having the appearance shown in FIG. 2. The web browser window 24 shows images similar to any web browser on the market, such as the Netscape Navigator. If, for example, the user has entered a uniform resource locator (URL) address in the address box 26 which directs the downloader 46 to the worldwide web 48, an HTML document is accordingly downloaded from the worldwide web. The HTML code which includes the information pertaining to the layout of the document is decoded by the interpreter 54 to provide such details. The resulting layout objects and their hierarchy thus created determine or represent the layout or flow of the text and graphics contained within each layout document.

The latter is thereby rendered and appears in the web browser window 24. Should the user wish to select the document for the Lime being displayed in the web browser window 24 into the computer document he is creating as viewed in the document window 28, he uses the mouse 16 to click on the URL displayed in the box 26 to drag the latter and drop it into an upper portion 30 of the document window 28. This document is rendered as part of the document being created and appears in the document window 28, previous HTML documents having been transferred into this composite document at an earlier stage as represented by the addresses 26a and 26b appearing in the window portion 30 in the same order as the order in which they were selected by the user from the web browser. At the same time, and not evident to the user from what he sees on the screen, a compiler 42 amends the composite layout file 58 to add to the layout objects already included in that file from the previous web pages, the layout objects of the web page just selected by the user, so that these layout objects from successive HTML documents are ordered in the same order as those documents were selected from the web browser by the user. At the same time, the HTML files 60 of the HTML document just selected are added to the composite computer document being created by the user, the latest portion of which is displayed in the document window 28.

URLs listed in a web page currently being viewed on the browser, or URLs in a list of ‘bookmark’ or ‘favourite’ on the browser may also be dragged and dropped in the portion 30 of the window 28.

Instead of dragging a URL displayed in the box 26 to said web page to the document being created, the user may key in the URL directly in the upper portion 30 of the document window 28.

If any web page is unavailable from the selected source, the user is informed and the entry is deleted from the document being created.

After an HTML document and its accompanying image files have been successfully downloaded, the HTML is now interpreted to determine the visual layout of the document. The process of interpreting HTML code is a free, open specification maintained by the World Wide Web Consortium (http://www.w3c.org). All variables associated with the HTML object are now filled in. The level of detail of data stored in the resulting layout objects may be more complex than in the average web browser, in order to select for user editing. The rendering system of automatically creating layout objects may therefore be considered analogous to the steps a user manually undertakes when creating a document using a page layout software package such as Adobe InDesign or Quark XPress.

Selected tools from the toolbar 22 and/or selected items in one of the menus 20 can now be used in the same way as in any typical word processing program to deal with the created document as one single document. Thus, for example, the editor 44 may be used to access all the HTML files 60 of all the HTML documents that make up the composite document via the composite layout file so as, for example, to delete every occurrence ot one particular word or phrase in the composite document, or replace it by another word or phrase. Another tool from the toolbar 22 may be used to save to disk the whole document, in a format in accordance with the present invention, which comprises data in the composite layout file 58. Another tool may be used to export the whole document as plain text or Rich Text Format. Another tool may be used to print out the created document on the printer 15.

Another tool from the toolbar 22 may be used to retrieve a document which has been previously saved in a format in accordance with the present invention, which again comprises data in the composite layout file 58.

Another tool may be invoked to cut and paste portions of the document being created. Every edit action such as this may change the layout objects which go to make up the document being edited. Consequential further alterations may be made to the hierarchy of the layout objects as well possibly resulting in movement of layout objects which appear further down the document than the position at which editing took place.

Another tool of the toolbar 22 may be used to jump directly to any copied web page in the created document by selecting its name from the list in the upper portion 28 of the document window 28.

Another tool from the toolbar 22 may be invoked to generate a table of contents indicating on which printed page each converted HTML document begins in the created document.

The program facilitates the maintenance of a list of important index words. It may also automatically generate a full lexical index indicating on which printed page or pages each such index words occur.

Links may be retained in the created document to enable them to be clicked on, thereby to retrieve the linked web page in the browser window 24. Another tool may be provided to enable the link URL in the created document to be clicked on to insert the linked web page into the created document.

The user's view of the created document in the document window 28 is akin to that of a typical word processor program, that is, a single vertically scrolling window of a width appropriate for the paper size and orientation selected for this document, containing all entries in the document, each drawn using the entry's root layout object and its children. The user may also select whether or not to view “page breaks”, gaps representing how the document would be split up when printed using the currently defined page setup. If not viewing page breaks, the user may also specify that particular entries are “collapsed” and are hidden from view to facilitate working with other entries. These options are considered when the hierarchy of layout objects is created when the entry is first rendered and whenever any user editing occurs.

The program may in addition retain as part of the created document an array of all the URLs invoked to call up the various HTML documents which together constitute the created document. In addition, it may retain as part of the created document the dates and times on which the web page of each URL was downloaded. One of the tools on the toolbar 22 may then be one which checks the web page at source as regards its last time and date of update, and if that is more recent then the date and time recorded in the created document, swap the old web page for the new with the created document, at the same time making any changes to the latest version of web page that were previously made to the earlier version in the created document.

From the foregoing description, in will be evident that certain non-document specific global parameters need to be set up by the program, as follows:

Whether or not to automatically render new entries when added

Default new document paper size

Number of simultaneous HTTP connections allowed

HTTP proxy server address

HTTPS proxy server address

Default font name and address

Default language encoding for pages without language specified.

From the foregoing description, it will also be evident that the format for each document created by the program comprises the following:

Global Variables

Page Setup/Print Setup parameters such as page size and margins

Parameters defining if and how a table of contents should be created

A list of glossary terms

Parameters defining if and how an index should be created

An array of any number of entry objects

Entry Object Variables

An HTML object

A string of all visible text characters used in the entry

An array of text attributes and their corresponding ranges (position and length) in the above string. HTML text attributes include font facer size, colour definitions, and more.

A layout root object

Date and time this entry was created

Date and time this entry was last rendered from the source web page

Whether or not this entry:

has been rendered from HTML

is “collapsed” (hidden)

should print its background colour or image

should print coloured text

HTML Object Variables

A single HTTP object containing the raw HTML representing this web page

An array of HTTP objects containing images referred to from this web page

An array of text objects containing link URLs on this web page

A corresponding array of text objects containing link descriptions on this web page

HTTP Object Variables

A URL indicating the origin of this object

The status of this object (empty, partially loaded, completely loaded, cancelled, and/or had an error)

A block of data, being a copy of the data referred to by the above URL (if this object has been loaded)

Raw HTTP header data received along with the above data.

Layout Object Variables

A rectangle defining the boundaries of this object as it would appear on screen or printed on paper

Definition of one of three states.

Object contains no text

Object encloses a specific range of visible text characters of the owning entry

Object may enclose a variable number of text characters, depending upon overflowed text from another layout object

If object is an overflow text holder, a reference to the other layout object to accept overflow from

It object is an overflow text holder, a reference to the layout object to overflow into, should the text not fit within this layout object

An array of pointers to any number of “child” layout objects contained within this layout object's rectangle.

It will thus be appreciated that the illustrated system enables a number of Internet HTML “worldwide web” pages to be accreted into a single document, editable in a direct, user friendly manner much like a word processor.

Numerous variations and modifications to the illustrated system may be made without taking the resulting system outside the scope of the present invention. To give an example, the rendering of each successive HTML document in the window 24 at the time they are selected may instead occur after a number of selections have been made, so that the user is not delayed by the rendering of one document before selecting the next. This is especially desirable if the apparatus and system being used is slow in effecting the rendering of a given document.

A further window may be provided in the document window 28 in which are automatically listed any links or references to other web pages in the web page for the time being addressed. Any one of these links may be dragged and dropped into the upper portion 30 of the document window 28.

Whilst the program has been described as one by which a series of HTML documents, for example web pages, may be compiled, the compilation could include one or more texts, images, or text/image combinations from other sources, such as word processor documents.

We claim:

1. A method of creating a computer document comprising downloading a plurality of hyper text markup language (HTML) documents and interpreting the HTML code of each HTML document downloaded to create a hierarchy of layout objects representing the flow of text and graphics contained within each said HTML document, wherein a series of layout objects of all said HTML documents downloaded are compiled, in user selected order, thereby to create a single user-editable computer document comprising said series and said HTML documents in that selected order, so that the document comprises a plurality of web pages as they appear in a web browser, but is editable as with a word processor as a single document.

2. A method according to claim 1, wherein at least one of said HTML documents is downloaded from the Internet.

3. A method according to claim 1, wherein the method further comprises providing an editing indicator to indicate whether any alterations have been made to said editable computer document since it was originally created.

4. A method according to claim 1, wherein the date on which each said HTML document was downloaded, as well as the address of each said HTML document, is retained in said editable computer document.

5. A method according to claim 4, wherein the method includes the steps of comparing the date of each said HTML document composing said editable computer document with the current date of the source of that HTML document, and transferring said HTML document from its source in the event that the latter has been updated since it was last downloaded to said editable computer document.

6. A method according to claim 5, wherein the method includes the step of incorporating automatically any alterations that have been made to said HTML document as it was when last downloaded into said editable computer document, to the updated HTML document now being incorporated into said editable computer document in place of that document as previously downloaded and edited.

7. A method according to claim 1, wherein the method includes the step of editing said editable computer document.

8. A method according to claim 1, wherein the method further includes the step of storing any associated textual information, graphical information, and source address of related HTML documents, provided at the source of each said HTML document downloaded into said editable computer document, in said editable computer document.

9. A method according to claim 1, wherein the method comprises the step of generating a fully formatted printout of said editable computer document.

10. A method according to claim 1, wherein the method includes the step of automatically generating a table of contents of said editable computer document.

11. A method according to claim 10, wherein that table of contents indicates on each page of said editable computer document each said HTML document composing said editable computer document.

12. A method according to claim 1, wherein the method includes the step of maintaining a list of selected index words constituting said editable computer document.

13. A method according to claim 12, wherein said step includes the automatic generation of a full lexical index indicating the locations in said editable computer document in which each index word appears.

14. Apparatus for enabling the creation of a computer document, comprising a downloader which serves to download a plurality of HTML documents, an interpreter connected to receive the HTML codes of the HTML documents downloaded by the downloader and to interpret them, thereby to create a hierarchy of layout objects representing the flow of text and graphics contained within each said HTML document, and a compiler which serves to compile a series of layout objects of all said HTML documents downloaded, in user selected order, thereby to create a single user-editable computer document comprising said series and said HTML documents in that selected order, so that the document comprises a plurality of web pages as they appear in a web browser, but is editable as with a word processor as a single document.

15. Apparatus according to claim 14, further comprising a connection of the apparatus to the internet to enable said HTML documents to be downloaded from the internet.

16. Apparatus according to claim 14, further comprising an editing indicator generator which serves to provide an indication of whether any alterations have been made to said editable computer document since it was originally created.

17. Apparatus according to claim 14, further comprising a retainer device which serves to retain the date on which each said HTML document was downloaded, as well as the address of each said HTML document, in said created editable computer document.

18. Apparatus according to claim 17, further comprising a comparator which serves to compare the date of each said HTML document composing said editable computer document with the current date of the source of that HTML document, and a transfer device which serves to transfer said HTML document from its source in the event that the latter has been updated since it was last downloaded to said editable computer document.

19. Apparatus according to claim 18, further comprising an editing device which serves to incorporate automatically any alterations that have been made to said HTML document as it was when last downloaded into said editable computer document, to the updated HTML document now being incorporated into said editable computer document in place of that document as previously downloaded and edited.

20. Apparatus according to claim 14, further comprising an editing device which enables said editable computer document to be edited.

21. Apparatus according to claim 14, further comprising a storer which serves to store any associated textual information, graphical information and source address of related HTML documents, provided at the source of each said HTML document downloaded into said editable computer document, in said editable computer document.

22. Apparatus according to claim 14, further comprising a printout generator connected to the rest of the apparatus, which printout generator serves to generate a fully formatted printout of said editable computer document.

23. Apparatus according to claim 14, further comprising a table generator which serves to generate a table of contents of said editable computer document.

24. Apparatus according to claim 23, wherein that table of contents indicates on each page of said editable computer document each said HTML document composing said editable computer document.

25. Apparatus according to claim 14, further comprising a listing device which serves to maintain a list of selected index words constituting said editable computer document.

26. Apparatus according to claim 25, wherein said list includes a full lexical index indicating the locations in said editable computer document in which each index word appears.
